(19) United States
(12) Patent Application Publication
(10) Pub. No.: US 2016/0371794 A1
(43) Pub. Date: Dec. 22, 2016

(54) SYSTEM FOR CONTENT COLLECTION IN A CURRENT WINDOW AND DISSEMINATION IN A WINDOW OF CURRENT ACCESS

(71) Applicant: BINDU RAMA RAO, LAGUNA NIGUEL, CA (US)

(72) Inventor: BINDU RAMA RAO, LAGUNA NIGUEL, CA (US)

(21) Appl. No.: 15/253,893

(22) Filed: Sep. 1, 2016

Related U.S. Application Data
(63) Continuation of application No. 14/106,109, filed on Dec. 13, 2013.
Application No. 14/106,109 is a continuation-in-part of application No. 12/925,417, filed on Oct. 21, 2010, now Pat. No. 8,639,764.

(51) Int. Cl. G06Q 50/00; H04L 12/58; H04L 29/08; H04L 29/06

(52) U.S. Cl. CPC G06Q 50/01; H04L 65/403; H04L 51/32; H04L 67/02; H04L 51/10

(57) ABSTRACT

An automated blogging, skills portfolio management system and syndication system that is capable of facilitating easy blog message posting by a multitude of people witnessing a sports event or some other public event, wherein players, spectators and others can provide comments and observation regarding that particular event while the event is going on. In fact, the present invention makes it possible for the players, spectators and others to provide comments and observations in the form of audio recording, that provide the context to any digital photos and videos they provide. The blogs can be automatically syndicated, newsletters are automatically distributed, based on messages posted, recommendations provided, etc.

### CROSS REFERENCES TO RELATED APPLICATIONS

The present patent application is a continuation (CON) of, claims priority to, and makes reference to U.S. non-provisional patent, Ser. No.14/106,109 FILED ON Dec. 13, 2013, entitled “AUTOMATED BLOGGING, SKILLS PORTFOLIO MANAGEMENT AND SYNDICATION SYSTEM”, docket number BRR2013SDJ02, which is a continuation-in-part (CIP) of, claims priority to, and makes reference to U.S. non-provisional patent, Ser. No. 12/925,417 filed on Oct. 21, 2010, entitled “AUTOMATED BLOGGING AND SKILLS PORTFOLIO MANAGEMENT SYSTEM”, docket number BRRSDJ01201U1. The complete subject matter of the above-referenced United States Patent Applications are hereby incorporated herein by reference in their respective entirety.

### BACKGROUND

1. Technical Field

The present invention relates generally to automatic blogging, and specifically to the use of mobile blogging and skills portfolio management combined with syndication.

2. Related Art

In the last decade, mobile devices of all kinds have proliferated all over the world. Some of them are small tiny cellular phones, others are more powerful and flexible smartphones, some are small electronic tablets and tiny netbooks, etc. All of these are very convenient to use.

The Internet is a very powerful communication means and quite often, the mobile devices available in the world can employ the Internet for communication. Most of them also employ the telecom networks (such as cellular networks) for communication. Some of the mobile devices can use both the Internet as well as the telecom networks for communications.

People using mobile devices such as mobile phones often find a camera embedded in the mobile phones and take pictures. Some of them are also capable of emailing these pictures to friends. Of late, some mobile devices have become capable of displaying digital videos and movies. Some of them are also able to capture small digital video clips.

Quite a few websites make it possible for a user to use his laptop or PC to upload photos to the websites. Such photos are typically uploaded to an album online and sometimes shared with friends. The YouTube service on the Internet makes it possible for a user to record a digital video and upload them from their laptop or personal computers to the YouTube server. Such videos can also be shared with friends.

There are currently no generally available means by which a group of people can simultaneously participate in creating a blog on a sports event that they are currently participating in, or witnessing, or for a outdoor entertainment event that they visit. There are no easy to use methods by which all the people watching a game can share their observations while they are viewing the game, especially if they have to share photos, observations, share videos, etc. There is no available solution currently in the market by which these players (in sports events) and spectators can make comments about a local sports match they are playing in or witnessing, while that match is going on. For example, if a youth soccer league match is being witnessed by several parents and other spectators, there is no easy way in which all of them can take pictures and share them among themselves and with others (such as their friends at schools, etc.). In addition, there are no easy means by which the players, spectators, etc. witnessing a match can share their observations regarding the match with others. What most people do is to take photos on their cameras or cellular phones and save them for subsequent (quite often after a few weeks) upload to online albums. Some of them, much later at home, sometimes several days later, upload it to a website album. They then send an email to their friends (assuming they know their email addresses, or some form of contact information, which is often not the case) asking them to view their online album. This is not only a laborious process but also time consuming and inconvenient. The recipients of these emails have to often use their laptops to read the emails and then visit the online album whose link may have been provided in the email. Quite often these albums contain several photos and the viewer does not know the details of each photo and does not know the context of individual photos.

There are currently no easy means by which a youth athlete can as create a skills portfolio. It would be useful if a youth athlete or sportsman could maintain a skills portfolio, such as the ones painters and other artists do, when they paint a number of canvases and carry them physically in their physical portfolios, so that they can show it to others, as needed. There are no easy ways in which a youth athlete can make such a portfolio of his/her sports skills for sharing.

Most young people are familiar with Facebook accounts and twitter services and often use them. But beyond following some tweets provided by celebrities and their favorite stars (such as Madonna), most young people don't find Twitter useful. Most young people in urban areas have access to computers and laptops and use them to maintain a Facebook account, through which they post their photos, and details of their hobbies, habits, personal lifestyles etc. Facebook pages are used to talk about their personal lives, share information about their idiosyncrasy, etc. In addition, Facebooks pages are full of personal details that are often not flattering, and are far from being professional.

Syndication of information and news of local high school musical performance, local band performances seldom occurs. Local newspapers seldom bother to report on such activities in their newspapers for several reasons, not the least of which is an inability to track such events, inability to send personnel to attend such small events, and an inability to find information on the participants in those events, such as small children or youth.

In view of the foregoing considerations, it is clear that there is a need for an improved system and method that is capable of facilitating easy blogging by a multitude of people/spectators witnessing a sports event or some other public event. There is a need for such spectators to share comments and observation regarding that particular event. There is a need for a solution wherein a user can generate sports blogs in an easy and automated fashion, and also to use such blogs, or some portion thereof, to share information with others. These things don't exist today. There is need for leveraging such blogs to create and manage skills portfolios, but such facilities do not exist today.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of an automated blogging, skills portfolio management and syndication system accessible via the Internet and telecom networks that facilitates easy blog message posting by a multitude of people witnessing a public or private event (such as a sports event or any other event), automated blog generation, skills portfolio management (such as a sports skill portfolio managed by a player or performer) and syndication.

FIG. 2 is a perspective block diagram of a system for automatic sports blogging and sports skills portfolio management which makes it possible for players and spectators in a live game to blog messages from their mobile device, wherein the messages comprise of a digital photo, an audio recording, a digital video recording, textual message or a combination thereof.

FIG. 3 is a flow chart of an exemplary operation of the server infrastructure 151 of an automated blogging and skil is portfolio management system.

### DETAILED DESCRIPTION OF THE DRAWINGS

The present invention provides an automated blogging, skills portfolio management and syndication system 105 that is capable of facilitating easy blogging by a multitude of people witnessing a sports event or some other public event, wherein players, spectators and others can provide comments and observation regarding that particular event while the event is going on. In fact, the present invention makes it possible for the players, spectators and others to provide comments and observations in the form of audio recording, that provide the context to any digital photos and videos they provide. The present invention makes it possible to simultaneously create a blog for that event, in an automated mode (without any special setup or extensive operations) that can be shared with others. Also importantly, the present invention makes it possible for players and others to leverage such blogs to create and manage skills portfolios for the players.

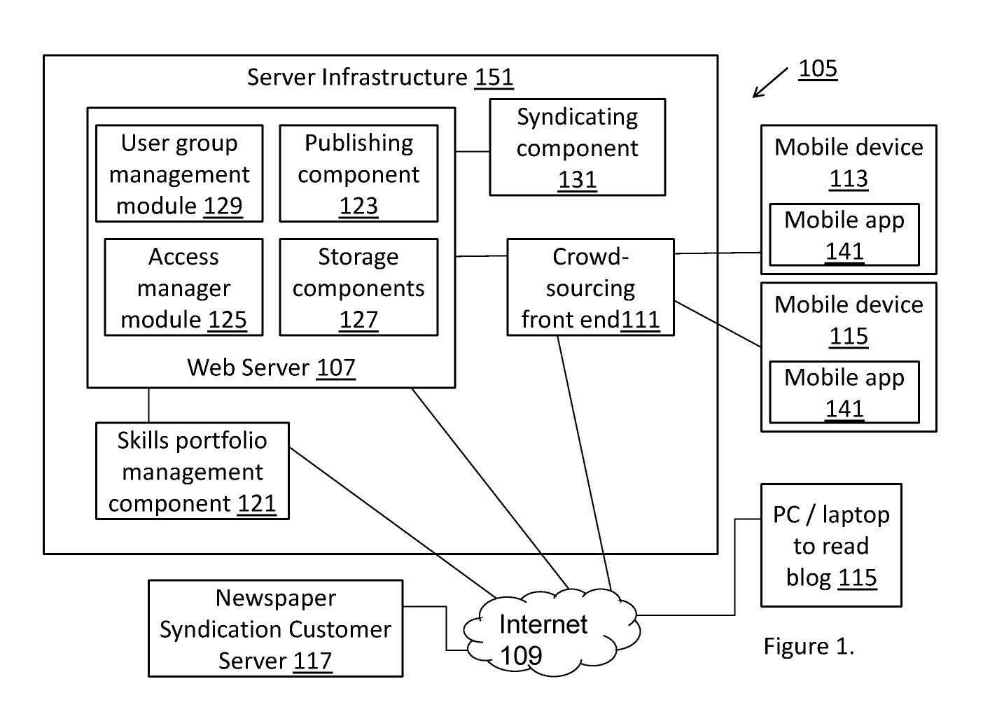

FIG. 1 is a perspective block diagram of an automated blogging, skills portfolio management and syndication system 105 accessible via the Internet and telecom networks that facilitates easy blog message posting by a multitude of people witnessing a public or private event (such as a sports event or any other event), automated blog generation, skills portfolio management (such as a sports skill portfolio managed by a player or performer) and syndication.

The automated blogging, skills portfolio management and syndication system 105 is accessible via the Internet and telecom networks. It comprises a server infrastructure 151 with a first interface configured to receive a plurality of messages from a plurality of mobile devices 113, 115, 141, each mobile device associated with at least one user, wherein each of said messages are associated with at least one participant. It also comprises a skills portfolio management component 121 that stores a plurality of skills portfolios, each associated with a different participant, wherein each skills portfolio comprises: a player profile of the associated participant; details of sports skills of the associated participant; inputs concerning the associated participant from other users; and recommendations for the associated participant. Each skills portfolio also comprises information on involvement and achievements of the participant in other non-athletic organizations and activities, feedback information concerning the associated participant, and achievements, awards, and other recognitions of the associated participant. It also comprises event performance information of the associated participant, academic interests and performance and contact information of the associated participant.

The server infrastructure 151 automatically incorporates the plurality of messages into corresponding skills portfolio among the plurality of skills portfolios, based on association with the corresponding ones of the at least one participant. The server infrastructure 151 is configured to store each of the plurality of messages and make them retrievable based on at least a current event, participant, and participant group.

The server infrastructure 151 also comprises a second interface to a publishing component 123. This second interface enables a mobile app 141, in mobile devices 113, 115, to make a request for a blog for a participant, a request for a blog for a participant group, such as a soccer team, a request for a newsletter that is automatically and dynamically generated, etc. The server infrastructure 151 configured to publish at least one blog based at least on the plurality of messages and to dynamically generate a blog for each of a plurality of participants and participant groups for review by said at least one participant, via a mobile device 113, or from a PC/laptop 115.

The server infrastructure 151 is further configured to collect into a skills portfolio recommendations, performance reviews and feedback received by the at least one participant. It supports management of the skills portfolio, and facilitates presenting for display the recommendations, performance reviews and feedback received by the at least one participant.

A parent (user) of a player (participant) who is part of an audience for a game can provide feedback for another player (another participant), a visiting coach for a team can provide a recommendation for a good player from an opposing team, etc. These parents and coaches are considered users, as opposed to the players who are considered to be the participants. Typically the messages, recommendations, the feedback are about participants, and comes from other participants or from users such as parents, coaches, etc.

The server infrastructure 151 also comprises a second interface to a publishing component 123, through which requests for publication of newsletters, blogs, syndication requests are received, and through which blogs are presented, or communicated to mobile devices 115 (for example to the mobile app 141 of the mobile device 115), etc. The server infrastructure 111 is configured to publish for any participant a skills portfolio information from the participant's skills portfolio, wherein the skills portfolio information comprises recommendations, performance reviews and feedback received by the participant. The server infrastructure 151 further configured to facilitate incorporation, by the at least one participant, of at least one of the plurality of messages, into the skills portfolio for the at least one participant. It facilitates management and selective sharing of the skills portfolio by the at least one participant, by at least specifying users who are authorized to at least access, review and comment on their skills portfolio. It helps manage the sharing of the skills portfolio with other entities, wherein the other entities are at least one of college recruiters, employers, sports organizations, schools, newspaper companies and advertisers. Thus college recruiters are allowed by a participant to view his skills portfolio. The college recruiters are authorized to view only certain subsets of the skills portfolio by the participant in a related embodiment.

The server infrastructure 151 also comprises the web server 107 (in one related embodiment, it is an external web server) that facilitates blogging by a plurality of participant groups, wherein the plurality of participant groups are also managed via the web server 107, wherein each of the plurality of participant groups comprises a list of members, wherein each member of the list of members can participate in posting messages to and accessing blogs from one or more of the plurality of participant groups.

The web server 107 facilitates posting of one of the plurality of messages from an associated one of the plurality of mobile devices 113, 115, by a member of the list of members of one of a plurality of participant groups. The plurality of mobile devices 113, 115 each employ a corresponding downloadable mobile app 141 that interacts with the web server 107 to retrieve messages provided by the web server 107 and to retrieve participant specific blogs, participant specific skills profile and participant group specific blogs.

The system 105 further comprises the publishing component 123 used by and managed by each of a plurality of participant groups. In a related embodiment, the publishing component 123 is part of the web server 107, and in another related embodiment, it is external to the server infrastructure 151. The publishing component 123 dynamically generates a blog for each of the plurality of participant groups for review using the downloadable mobile app 141 on one of the plurality of mobile devices 113, 115. The web server 107 also facilitates review of the blog for each of the plurality of participant groups over the Internet 109.

The system of claim 1 further comprising:

the skills portfolio management component facilitating, via a web server associated with the server infrastructure, the management of the participant's skill portfolio, wherein the management comprises editing, enhancing, replacing, modifying, sharing, adding, or deleting at least one portion of the participant's skill portfolio.

The system 105 comprises the skills portfolio management component 121 that automatically groups participants based on skill levels and performance. In a related embodiment, the skills portfolio management component 121 is part of the web server 107, and in another related embodiment, it is external to the server infrastructure 151.

The skills portfolio management component 121 facilitates solicitation of recommendations and performance reviews by the at least one participant, and selective incorporations of recommendations and performance reviews received subsequently into a corresponding skills portfolio. The at least one participant has the ability to deny or block access to his skills portfolio or to subsets thereof. Thus, the participants can customize which portions or elements of their skills portfolio is presented/visible to other users, such as college recruiters, parents, teachers, other participants, other participant groups, etc.

In one embodiment, the publishing component 123 automatically generates a newsletter and publishes it as syndication to a plurality of syndication subscribers. In a related embodiment, the syndication employs RSS technology.

In another embodiment, the publishing component 123 offers affiliate management services, syndicated offer management services, automated digital product assembly and deployment services, and the creation of built-to-order digital content products. Key features/services of publishing component 123 include, but are not limited to:
skills portfolio data are cleaned and validated (against other data or searching other databases).
skills portfolio enhancements such as local newspaper reports, local community data, school information
ability to display a participant's skills portfolio on the web site managed by the web server 107 with special emphasis and/or priority placement based on certain criteria such as achievements
ability to feature a skills portfolio in opt-in email alerts for field requests for access to the skills portfolio via email or via website
RSS/XML feeds—for syndication by newspapers, publishers, participants, external servers, etc.
Social marketing (Facebook, Twitter, Google+, etc.) interfaces and forwarding

The automated blogging and skills portfolio management system 105 comprises a crowd-sourcing front end 111 capable of receiving a plurality of messages from a plurality of mobile devices 113, 115 wherein each of the plurality of messages comprises at least one of a digital photo, a user recorded audio, a digital video and a textual input. It also comprises a web server 107 communicatively coupled to the crowd-sourcing front end 111 that facilitates processing of the plurality of messages and storage of the plurality of messages in storage components 127, and a publishing component 123 that is used to publish at least one blog based at least on the plurality of messages.

The web server 107 associates each of the plurality of messages with a current event. For example, if a group of people watching a college football game post blogging messages from the mobile devices 113, 115, the associated event is the football game, a reference to which is maintained by the web server 107, and that reference is incorporated into the plurality of blogging messages posted by the group of people during the match, and soon after that match. These messages can include observations and comments made, in textual form with textual inputs, in audio form using recorded audio messages, etc.

The web server 107 provides the plurality of messages in a blog that is created in an automated fashion, and it also provides them to the mobile devices 113, 115 as messages posted to an associated user group. Specifically, the web server 107 provides access from the plurality of mobile devices 113, 115 employing a downloadable mobile app available in the plurality of mobile devices 113, 115.

The web server 107 employs the publishing component 123 to dynamically generate a blog that is associated with the current event (sporting event or any other event), based on the plurality of messages received for that current event, wherein the blog is accessible on the Internet and telecom networks. The collection of messages received for the current event is managed by the web server, and a current event message window is selectively employed. For example, for a football game event at a high school, the current event message window may open up on the previous day and it can close on the day of the football game, immediately after the end of the game.

A skills portfolio management component 121, communicatively coupled to the web server 107 and to the publishing component 123 makes it possible for a user to create and manage a skills portfolio. For example, a youth athlete can create a skills portfolio, include references to the blog in that skills portfolio, add personal details and contact information, and share that with college recruiters and others. In general, the skills portfolio management component 121 facilitates incorporation, by a user, of at least one of the plurality of messages, into a skills portfolio associated with the user, that is selectively accessible from the Internet and telecom networks.

The web server 107 facilitates blogging for a plurality of user groups that are managed via the web server 107. In specific, it comprises a user group management module 129 that facilitates user group management. Each of the plurality of user groups comprises a list of members, wherein each member of the list of members can participate in posting blogging messages to blogs associated with an individual user group. Members can also access these individual blogs, from more than one of the plurality of user groups based on their membership to these user groups. Such access can be over the Internet or over telecom networks (such as cellular networks), and they can be via PC/laptop 115 with browsers or mobile devices 113, 115 with a specific downloadable mobile app (such as the SportsDuJour mobile app, DanaView mobile app, etc.). In addition, for mobile devices 113, 115 that comprise micro browsers, the blogs can also be accessed using these micro browsers, although sending of messages to these blogs would require the downloadable mobile app for easy and convenient blogging. An access manager module 125 of the web server 107 facilitates access to blogs, processing membership requests to user groups, access security information management, etc.

The web server 107 facilitates the posting of one of the plurality of messages from an associated one of the plurality of mobile devices 113, 115, by a member of the list of members associated with one of the plurality of user groups. The storage components 127 are associated with one or more of the plurality of user groups. The plurality of mobile devices 113, 115 each employ the downloadable mobile app 141 to post blogging messages, to review messages provided by the web server 107 and to review user group specific blogs.

The selective automatic incorporation of posted messages into a user's skills portfolio is supported by the web server 107. For example, a youth athlete can configure his user account such that blog messages (comprising digital photos, audio recording, digital video content, etc.) from specific contributors (parents, coaches, etc.) can be automatically included into the skills portfolio for that user. In a related embodiment, all messages from a specific user account or phone number are processed and incorporated into the skills portfolio for that user. The youth athlete can subsequently edit them, delete them or accept them as presented, using the skills portfolio management component 121.

The skills portfolio management component 121 facilitates creation of “recommendations”, “performance reviews” and “feedback”, and their management by a user. For example, a youth athlete can receive audio, digital video and/or textual recommendations from one or more people, such as from his coaches, teachers, etc. The web server 107 provides web pages that facilitate such interactions by a user with the skills portfolio management component 121. These recommendations can be ‘accepted’, ‘rejected’ or ‘deleted’ by a user (such as a youth athlete).

In one embodiment, the skills portfolio management component 121 as well as the crowd-sourcing front end are part of the web server 107.

In one embodiment of the automated blogging and skills portfolio management system 105, a publishing component 123 is associated with each of the plurality of user groups that are currently available, and the publishing component 123 dynamically generates a blog for each of the plurality of user groups for review by a user. Such review can be conducted using the downloadable mobile app 141 on one of the plurality of mobile devices 113, 115. The web server 107 also facilitates review of the blog for each of the plurality of user groups over the Internet. For example, it presents the blog in user group specific web pages provided for blog review purposes.

In one embodiment, the skills portfolio management component 121 facilitates the incorporation a blog message created by a member of one of the plurality of user groups into a corresponding user's skill portfolio. For example, if a parent of a youth athlete is a member of a soccer club group, and blogs a message during a soccer match, the blogged message is automatically incorporated into the skills portfolio of the youth athlete. The youth athlete can subsequently edit it or modify it, as necessary. Or he can accept it as it is and use it as part of the skills portfolio.

In general, the skills portfolio management component 121 facilitates, via the web server 107, the management of the user's skill portfolio by a user (such as a member of one of the plurality of user groups), wherein the management comprises editing, enhancing, replacing, modifying, sharing, adding, or deleting at least one portion of the user's skill portfolio.

In one embodiment, the web server 107 facilitates the retrieval of message from a mobile device 113 based on the associated user group. For example, it facilitates retrieval from the mobile device 113 for review as a message in a list of available relevant messages, or as part of a blog for that user group. The web server 107 also facilitates the retrieval of the message using mobile device 113 based on a current event, such as a championship game for the season.

The user group management module 129 makes it possible to create user groups, manage user groups, add members to them, delete members, etc. In one embodiment, the plurality of user groups managed by the user group management module 129 are sports related groups and wherein the list of members for each of the plurality of user groups comprises players, their parents, sports fans and spectators. In a different embodiment, the plurality of user groups managed are music related groups (such as orchestra music group, high school band group, choir group, jazz group, etc.) and wherein the list of members for each of the plurality of user groups comprises players of musical instruments, their teachers, and parents, etc.

The publishing component 123, in general, helps publish a blog based on received blog messages, such as those posted by spectators/audiences during a live event. For example, it helps publish a sports blog for each of the plurality of sports related user groups created and maintained by the automated blogging and skills portfolio management system 105.

The automated blogging and skills portfolio management system 105 also comprises a syndicating component 131 that makes it possible to share the various blog (sports related, music related, education related, etc.) with one or more external servers associated with news paper companies as part of syndication operation. For example, all high school sports related blogs are customized for a newspaper syndication customer and presented via a special syndication front end (look and feel customized as necessary) to a newspaper syndication customer server 117 (newspaper company) that selectively reuses a portion of one or more blogs in its online or printed versions of newspaper editions. In addition, the same blogs (or more specifically, a current edition/version of those blogs as they pertain to an event of interest) are forwarded to newspapers and magazines (that are part of the syndication group) as an RSS (Really Simple Syndication) feed.

In general, event specific blogs are dynamically created and presented by the skills portfolio management system 105. In addition, the blogs for the plurality of user groups is created dynamically based on messages received for those groups from the plurality of users experiencing, viewing or participating in those events, the messages being sent primarily from their mobile devices, such as cellular phones, tablets, netbooks, smartphones, laptops etc.

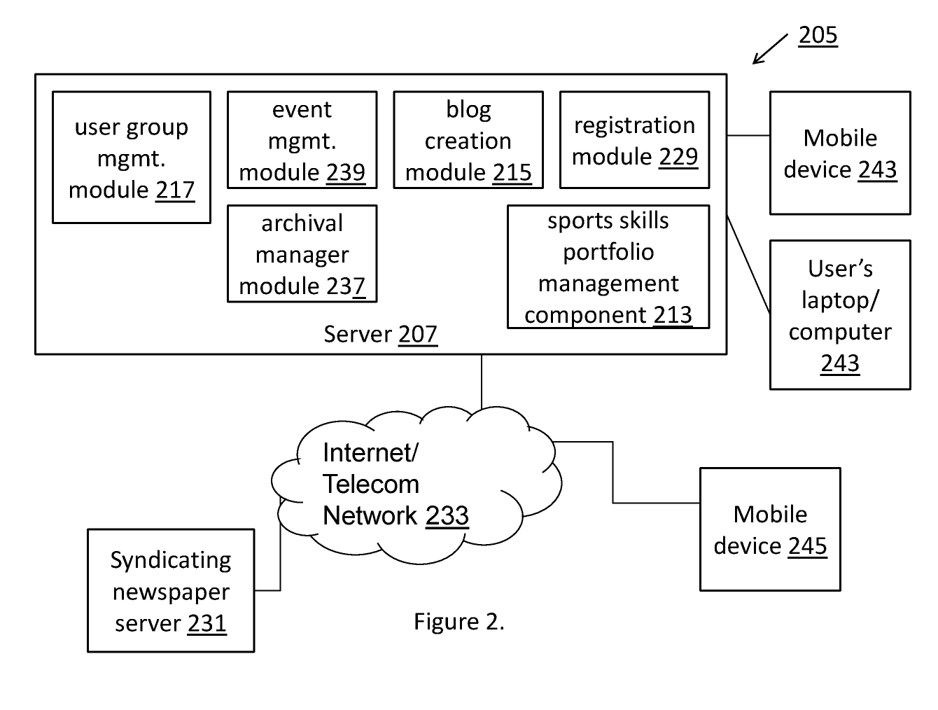

FIG. 2 is a perspective block diagram of a system for automatic sports blogging and sports skills portfolio management 205 which makes it possible for players and spectators in a live game to blog messages from their mobile device, wherein the messages comprise of a digital photo, an audio recording, a digital video recording, textual message or a combination thereof. The system for automatic sports blogging and sports skills portfolio management 205 comprises a server 207 capable of collecting messages from a plurality of user's laptop/computer/ mobile device 243. The mobile devices 243, 245 are used by players and spectators during a sporting event, wherein each of the messages posted by them comprises at least one of a digital photo, an audio recording and a textual input. The server 207 automatically presents a blog associated with the sporting event (such as a varsity state championship match), based on the messages posted. Other users can access the blog over the Internet and telecom networks or using a downloadable mobile app on their mobile devices 243.

The system 205 retrieves a skills profile from a corresponding skills portfolio to present to a first user (on to his mobile device 245, his user's laptop/computer 243, etc.). The system 205 has access to a skills portfolio of a plurality of participants, and the system 205 comprises at least one processor configured to receive a request comprising a participant identification and identify a target participant, retrieve a participant profile presentation preference based on the participant identification, comprising the preferences of a participant among a plurality of participants, wherein the participant is associated with one or more recommendations, messages, photos, videos, achievement awards, events and organizations. The at least one processor in the system 205 also retrieves for the target participant, based at least on the participant identification, a presentation set comprising :
messages;
a player profile;
details of sports skills;
inputs concerning the target participant from other users;
recommendations;
involvement and achievements in other non-athletic organizations and activities;
feedback information;
achievements, awards, and other recognitions; event performance information; and contact information; and
display the presentation set or communicate the presentation set.

The at least one processor (or the at least one server in some embodiments) of the system 205 is further configured to determine other participants who typically participate in activities with the target participant, who are members with the target participant in a participant group, and to identify, in the presentation set, recommendations, messages, feedback and awards provided by the other participants or involving the other participants, and highlight them.

In one embodiment, a first user (such as a user using the mobile device 243) of the system 205 is an reader authorized to access one or more skills portfolios on server 207, such as a college recruiter, a sports team recruiter, a newspaper reporter, etc. Such a first user, for example, is an authorized reader with access privileges provided by the target participant, wherein the presentation set is communicated to the authorized reader after verifying a reader authorization, wherein the reader authorization is provided by the target participant prior to access by the authorized reader.

In one embodiment, the at least one processor is embodied in a server 207 that comprises a sports skills portfolio management component 213 that facilitates management of a sports skills portfolio by each of the registered players. A registration module 229 facilitates player registration, and each player (youth athlete in general) is presented a player profile and a player sports skills portfolio, that they can then manage, and share with others. Parents of players, their friends, and other sports fans too, can register (via the web server 207 or the mobile device 243) to a) become members of one or more sports related user groups, b) acquire a downloadable mobile app that can be installed on their mobile devices 243, that facilitates blogging to those sports related groups c) post blog messages from their mobile phones 243 and laptops as they are watching a match/game/sports event. In a related embodiment, the server 207 is implemented as a hosted managed server infrastructure in a data center with a plurality of servers that interact and a load balancer in the front. In another embodiment, the server 207 provides a search facility to let a user using a mobile device 245 search and locate a skills portfolio for a friend or for another player on his sports team, etc. The search facility, in another embodiment, results in retrieving a list of possible participants (based on the search criteria, for example) and may just provide a public version of a selected skills portfolio if the person searching does not have a proper authorization to see a complete version with all the portions being accessible/viewable.

The sports skills portfolio management component 213 enables the addition of one or more posted messages (from the blog created) by one of the players into a corresponding sports skills portfolio. The sports skills portfolio management component 213 also facilitates selective sharing of the sports skills portfolio managed by the players with other users and with authorized external entities. It also facilitates solicitation of recommendations by the players from coaches, teachers and friends, etc.

The posted blog messages from the plurality of mobile devices 243, 245 typically originate at the sporting event and are sent by users who are players, coaches, spectators and sports fans. The sporting event is listed at the server 207, and the blog associated with the sporting event is automatically created by the server and presented for review by users, and it comprises at least one or more of these blog messages posted live by users during a sporting event.

A blog creation module 215 in the web server 207 manages automatic blog creation for a sporting event. An event management module 239 in the web server 207 makes it possible to enter information regarding sporting events and subsequently monitor messages collected for those events. It facilitates collection of blog posts by users during a sporting event, accepting blog posts between a start time and a stop time (in general). The blogging is thus “open” for a certain window of blogging” between the start and stop times specified by a event manager (a user in charge of that particular event). The server 205 facilitates addition, modification and enhancement to a blog associated with the sporting event after collecting messages from the plurality of mobile devices for a sporting event.

Blogs for a sporting event are in a current state for a few days, called the ‘window of current access’ and then become a target for archival. The server 207 facilitates archival of the blog after a window of current access expires. An archival manager module 237 in the web server 207 is responsible for archival of blogs, and it handles all management of archived blogs. The server 207 makes the blog available for access using a personal computer or the plurality of mobile devices during the window of current access. When it expires, the blog goes into an archived state, from which the user can still retrieve it, as necessary.

Each of the posted blog messages comprises at least one of a digital streaming video, a recorded digital video, a streaming audio and recorded audio. For each blogging message posted, the server compiles a primary player identification, an event identification, a location identification, a message contributor identification, an event date, an organization identification, and a region identification. For example, if a blogging message is posted by a user using the mobile device 243 or 245, the primary player identification is determined from user input provided or from a registration information stored by the registration module 229 (that identifies the primary player). The event identification is determined based on current active events, or from user input provided. A location identification is determined from event information available at the server 207, or from GPS coordinates 9 or other GPS information) provided b y the mobile device 243. A message contributor identification is determined by a user account information for the user, or from a phone number for that user (entered by the user or retrieved from his registration information). An event date is determined from a calendar of events maintained by the server 207. An organization identification is determined from user input from the blog or from an organization associated with the primary player identification. A region identification is solicited from the user or determined from a combination of sources—primary player identification, GPS coordinates, calendar entries, and organization details.

A user group management module 217 facilitates creation of user groups for various sports groups, sports clubs, sports teams, etc. It facilitates addition of members to those user groups, such as addition of players, etc. It helps maintain lists of players of various sports teams, clubs, etc. It also makes it possible to identify primary player identifications for other blogging users, such as parents of players (or their friends, etc.)

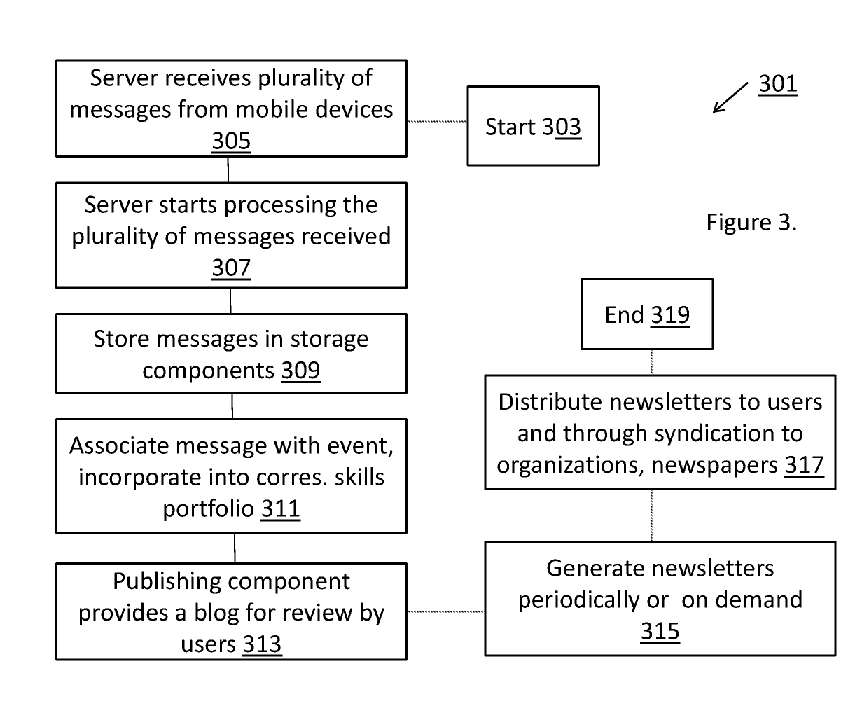

FIG. 3 is a flow chart of an exemplary operation 301 of the server infrastructure 151 of an automated blogging and skills portfolio management system 105. The processing starts at a start block 303 when the user's blog message is received by the server infrastructure 151. Typically, a user of the mobile device 113, that comprises the necessary and compatible mobile app, takes a photo, records a message and creates a message to be blogged/posted. Then the user selects a user group from a list those that the user is currently a member of (or associated with) and posts the message. The message is communicated to the server infrastructure 151. If the sender of the user's blog message is currently not known (a new user), a new account is automatically created (at least a temporary one). If the sender is a known sender, and if the event associated with the new blog message is a new event, then it is noted, and the new event is tracked (at least for a while).

Then at a next block 305, the server infrastructure 151 receives a plurality of messages from a plurality of mobile devices, each mobile device associated with at least one user, wherein each of said messages are associated with at least one participant. At a next block 307, the server processes the received messages, makes new user accounts if necessary (in automatic mode) and records new participant groups if necessary, etc.

At a next block 309, the server infrastructure 151 stores, using the skills portfolio management component 121, a plurality of skills portfolios, each of the plurality of skills portfolios being associated with a different participant, wherein each skills portfolio comprises:
a player profile of the associated participant;
details of sports skills of the associated participant;
inputs concerning the associated participant from other users; and
recommendations for the associated participant;
involvement and achievements of the participant in other non-athletic organizations and activities;
feedback information concerning the associated participant;
academic interests and performance information for the associated participant;
achievements, awards, and other recognitions of the associated participant;
event performance information of the associated participant; and
contact information of the associated participant;

The server infrastructure 151 stores each of the plurality of messages and making them retrievable based on at least on a. current event, participant, and participant group.

Then, at a next block 311, the server infrastructure 151 associates messages with corresponding event(s), and then incorporates, automatically, the plurality of messages into corresponding skills portfolio among the plurality of skills portfolios, based on association with the corresponding ones of the at least one participant.

At a next block 313, the publishing component 123 is ready for publishing messages as part of blogs, newsletters, etc. The server infrastructure 151 uses the publishing component 123, wherein publishing comprises at least the following:

presenting at least one blog based at least on the plurality of messages; and

generating dynamically a blog for each of a plurality of participants for review by said at least one participant;

The skills portfolio management component incorporates any recommendations and feedback received, into skills portfolio of corresponding participants and participant groups (NOTE: participant groups themselves can receive feedback, recommendations, etc.).

At a next block 315, the publishing component 123 generates periodically for the participant groups, and when requested, newsletters comprising some of the plurality of messages, recommendations and feedback and determines whom to distribute them to. At a next block 317, the publishing component 123 distributes the newsletters through online syndication. For example, it distributes newsletters to organizations, sports clubs, TV stations, newspapers, etc. through syndication (RSS based syndication, for example). It also distributes newsletters to users onto their mobile devices and computers, etc. Finally processing terminates at the end block 319.

In one embodiment, the exemplary operation 301 of the server infrastructure 151 of an automated blogging and skills portfolio management system 105 also further comprises, collecting recommendations, performance reviews, etc. supporting management of the skills portfolios, sharing them, and presenting them for display on websites and on mobile devices.

After the block 319, at a next block 321 (not shown), the server infrastructure 151 collects into corresponding skills portfolios, additional recommendations, performance reviews and feedback received by the at least one participant. Then at a next block 323, it supports management of the skills portfolio by the at least one participant. At a next block 325, it starts sharing selectively the skills portfolio with users authorized by the at least one participant. It also sends notification to users about availability of new messages, if desired by the corresponding participant. At a next block 317, server infrastructure 151 presents for display the recommendations, performance reviews and feedback received by the at least one participant. Finally the operation terminates.

In one embodiment, additional activities conducted by the web server include managing a sports skills portfolio, as instructed by a user, (using a computer or one of the plurality of mobile devices). Typically, managing comprises creating a sports skills portfolio for the user, adding at least one of the plurality of messages to the sports skills portfolio, entering, optionally, a reference to a specific blog or sporting event into the sports skills portfolio, entering user details and contact information, using the web server; and storing the sports skills portfolio in the storage components.

In another embodiment, additional activities conducted by the web server include sharing the sports skills portfolio with other entities, wherein the other entities are one of college recruiters, sports organizations, schools, newspaper companies and advertisers.

As one of ordinary skill in the art will appreciate, the terms “skills”, as may be used herein, include all types of skills, such as academic skills, sports skills, debating skills, art related skills, musical skills, etc.

As one of ordinary skill in the art will appreciate, the terms “messages” and “Hogging messages,” as may be used herein, include all types of messages posted to be blogged (for example from a mobile device) by users witnessing or participating in events, such as parents, coaches, siblings, etc. The terms “events” includes sporting events such as football and basket ball games, musical events such as the orchestra, concerts, etc.

Although the present invention has been described in terms of sporting events, it must be clear that the present invention also applies to other types of events and entertainment means.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components. application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An infrastructure comprising storage components and a web server, the infrastructure further comprising:
a manager that accepts posted content only during a current window from a plurality of mobile devices associated with a corresponding plurality of users;
the manager associates content posted during the current window to a current event;
the manager also correlates all posted content during the current window to one or more corresponding participants involved in the current event;
the web server provides access to the posted content only during a window of current access and then archives them automatically; and
a publication manager that, during the window of current access, customizes the posted content for a newspaper syndication customer and presents them to a newspaper syndication customer server, and also customizes the posted content for a magazine syndication customer and presents them to a magazine syndication customer server.

2. The infrastructure of claim 1 wherein an event manager configures a start time and stop time for the current window and a start time and stop time for the window of current access, wherein the current window and the window of current access are customizable per event.

3. The infrastructure of claim 1 wherein the publication manager dynamically publishes a blog associated with the current event based on at least a subset of the content associated with the current event.

4. The infrastructure of claim 1 wherein the web server receives a plurality of messages from the plurality of mobile users via their corresponding mobile devices, wherein each of the plurality of messages comprises at least one of a digital photo, a user recorded audio, a digital video and a textual input.

5. The infrastructure of claim 1 further comprising:
a skills portfolio management component that facilitates, via the web server, incorporation of a new posted content into a first user's skill portfolio, and management of the first user's skill portfolio, wherein the management comprises editing, enhancing, replacing, modifying, sharing, adding, or deleting at least one portion of the first user's skill portfolio.

6. The infrastructure of claim 1 wherein the manager, on receiving a new posted content, determines a user group with which the new content is to be associated; and
wherein the manager, on receiving a new posted content, dynamically determines a primary participant, the sender and the current event with which the new content is to be associated.

7. The infrastructure of claim 1 wherein the manager provides user interaction and selection capability to facilitate identification of a primary player by each of a plurality of users for new content provided.

8. The infrastructure of claim 1 wherein the publication manager customizes at least a subset of the posted content associated with an event into a new blog and makes it available for access to the plurality of users over corresponding personal computers and mobile devices during the window of current access.

9. The infrastructure of claim 1 wherein the publication manager receives a plurality of messages posted by the plurality of users during the current window and incorporates them into a blog.

10. The infrastructure of claim 1 further comprising:
a skills portfolio management component that incorporates at least one of the content posted into a skills portfolio associated with one of the plurality of mobile users; and
the skills portfolio facilitating, via the web server, enhancements by the one of the plurality of mobile users incorporating local newspaper reports, local community data, awards, graduation certificates, extra-curricular and academic school information.

11. The infrastructure of claim 10 further comprising:
the skills portfolio is selectively shared with external servers; and
the skills portfolio is selectively shared with selected users via the web server.

12. The infrastructure of claim 11 wherein the skills portfolio is shared with other entities during a entity specific window of access, wherein the each of the other entities are one of college recruiters, sports organizations, schools, newspaper companies, television stations, and advertisers.

13. The infrastructure of claim 1 further comprising:
a skills portfolio management component that incorporates at least one of the content posted and at least one of a plurality of messages posted, into a personal skills portfolio associated with a first user among the plurality of mobile users; and
wherein the skills portfolio management component configures the first user's personal skills portfolio such that content and messages from specific contributors among the plurality of mobile users are automatically included into the personal skills portfolio for the first user.

14. The infrastructure of claim 1 wherein messages sent by a plurality of users during the current window to a current event are stored for subsequent sharing as a blog entry, as a part of a skills portfolio, or as a newsfeed that is syndicated.

15. The infrastructure of claim 14 wherein each of the posted content and messages sent by the plurality of users are retrieved employing a message contributor identification, a phone number, an event date, an organization identification, a region identification, GPS coordinates, a calendar entry, and organization details.

16. The infrastructure of claim 1 wherein the posted content is shared with advertisers.

17. A server comprising storage components and a web server, for posting messages and content by a plurality of users, the server further comprising:
an event manager that provides the plurality of users a list of events;
the event manager receives from each of the plurality of users, via corresponding ones of a plurality of mobile devices, optional selection of a personal target event from the list of events, and content and messages posted;
a content manager accepts posted content and messages only during a corresponding current window for each of the events in the list of events, from the plurality of mobile devices associated with the plurality of users, wherein the posted content are each automatically associated with the personal target event;
the web server provides access to the posted content and messages only during a window of current access and then archives them automatically;
a publishing component that dynamically generates at least one blog that is associated with at least one of the events from the list of events, employing the posted content and messages; and
a syndicating component that selectively shares the posted content and messages, and the at least one blog, with one or more external servers associated with television stations, news related organizations, music related organizations, education related organizations, or sports related organizations, as part of a syndication service.

18. The server from claim 17 further comprising:
a user group management module that facilitates creation of a plurality of user groups related to sports and academic activities, wherein a list of members managed by the user group management module for each of the plurality of user groups comprises players, their parents, sports fans and spectators of events from the list of events.

19. A server comprising storage components and a web server, for posting messages and content by a plurality of users, the server further comprising:
a content manager that accepts posted content and messages only during a current window from a plurality of mobile devices associated with a plurality of users, wherein the content manager automatically determines and assigns an event for each of the posted content, wherein some of the plurality of users are participants who are subjects of the content while others are non-participants who are associated with one or more participants;
the web server provides access to the posted content only during a window of current access and then archives them automatically; and
a publishing component that dynamically generates at least one blog that is associated with the event for each participant, based on the posted content.

20. The server of claim 19 further comprising:
a skills portfolio manager that maintains a skills profile for the plurality of users who are participants based on inputs from corresponding participants and based on the posted content and messages; and
the skills portfolio manager provides selective access to the skills profile to the plurality of users who are participants, for reviewing, editing and sharing with selected non participants and with external servers.
